(19) United States
(12) Patent Application Publication
(10) Pub. No.: US 2007/0093406 A1
(43) Pub. Date: Apr. 26, 2007

(54) Novel cleaning process for masks and mask blanks

(76) Inventor: Omoregie Henryson, Beacon, NY (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/354,237

(22) Filed: Feb. 15, 2006

Related U.S. Application Data
(60) Provisional application No. 60/729,244, filed on Oct. 24, 2005.

(51) Int. Cl. B08B 3/00; C11D 17/00

(52) U.S. Cl. 510/421; 134/26; 134/29

(57) ABSTRACT

This invention includes processes that employ alkaline-based compositions with varying pH values and conductivities for use in surface preparation steps of substrate surfaces, such as quartz, particularly those used for photomask applications. Controlling pH values is an aspect of the invention in quartz surface cleaning, i.e., maintaining a higher pH value of the first chemical mixture than of the second chemical mixture yields higher particle removal efficiency compared to going from lower pH to higher pH. Preferably, the inventive process is an acid-free process.

This application is related to U.S. 60/729,244 filed on Oct. 24, 2005, which is incorporated herein by reference.

Disclosed are cleaning processes that combine an ultra-dilute RCA1, herein referred to as ultra-dilute Standard Clean-1 (_{ud}SC1), , at a predetermined dilution ratio and predetermined pH value and a different non-ionic solution mixture having slightly lower pH value. Both _{ud}SC1 and the nonionic solution are alkaline-based. Combined effects of these solutions is an aspect of conditioning substrate surfaces, such as, quartz surfaces, and for controlling particles, defects, metals, light and some heavy organics, and inorganic contaminations on quartz or other substrate surfaces. The invention process entails 6-sequence steps that include (i) frontside and backside alkaline clean and rinse, (ii) plate edge Wall clean (4 corners of substrate), (iii) backside scrub with megasonic, spin and rinse, (iv) frontside scrub with megasonic spin, rinse and dry, (v) dehydration heat, and (vi) dehydration cool. The process sequence preferably excludes acid-based cleaning.

This novel invention is directed to processes and apparatus employing alkaline-based compositions having varying pH values and conductivities for use in the surface preparation steps of substrate surfaces, and kits including such compositions. The invention achieves controlling particles, defects, metals, light and heavy organics, plus inorganic contaminations on substrate surfaces, for example, quartz materials.

More particularly, the invention is directed to processes using alkaline-based compositions in a predetermined order to each other with varying pH values and conductivities for the surface treatment, preparation, cleaning or conditioning of substrate surfaces, e.g., quartz materials, photo, e.g., mask blanks and/or other electronic components, prior to, for example, metal or metal film deposition. Surfaces after the deposition of a metal or a metal layer are also cleanable by processes according to the invention. In addition, this novel process helps to expose defects that are not generally captured by inspection tools after lapping and polishing processes of incoming quartz materials. The exposure of these samples to the alkaline-based solutions does help reveal the pits and valleys on the surfaces, hence captured by the inspection tools as defects or particles. These substrates with deposited metal or metal film on them are useful for the production of, for example, advanced binary products. The advanced binary products, typically, are composed of two metal film layers in addition to an anti-reflective coating (ARC) or layer. The anti-reflective coating acts as a diffusion layer. These products include, for example, 70 nm and 100 nm products, which preferably contain a metal film that is 70 nm to 100 nm thick. The 70 nm products have lesser than 20 percent high reflectivity and have high reflectivity values at wavelength of 248 nm of which more than 40% of incident lights are reflected off the surface. The 100 nm products have low reflectivity values at wavelength of 365 and 488 nm of which less than 20% of the incident lights are reflected off the surface. Both of these products are popular with customers, with the high reflectivity products being more suitable for today's market. The invention is further directed to kits including such compositions designed for or useful in practicing the processes of the invention.

RCA clean, which was developed about 40 years ago, is still the basis for most wet cleans for substrate surfaces. A typical RCA-type cleaning method includes an SC1 cleaning step with a NH₄OH:H₂O₂:H₂O composition, which is effective in removing particles and/or an SC2 cleaning step with an HCl:H₂O₂:H₂O composition, which is effective in removing metals.

Solvents as cleaning agents were once thought to be particle generators on surfaces. With shrinkage of device architecture, the industry moved by introducing standard chemicals as alternatives even for BEOL (back-end-of-line) cleaning processes. Widely used is the SC1 chemistry in low concentration (1:1:20) showing a 99% removal efficiency for >0.2 μm particle size (STMicroelectronics). Factors that are advantages of _{ud}SC1 over the traditional SC1 are reduction of surface roughness, shorter rinse time, lower ionic strength corresponding to retardation of deposition and re-deposition of particles, and reduction of ESH impact and CoO.

Etch Mechanisms of SC1

In basic solutions, natural repulsion usually exists and etching can lead to particle removal. However, in low ionic strength solutions (10⁻³ to 10⁻⁴ mole per liter) at moderate pH (7 to 9) particles in general would not deposit on SiO₂ or Si surfaces. But in high ionic strength solutions deposition will in general occur despite repulsion even though the range of interaction is significantly reduced.

SC1 Mechanism of Reaction:

a) H₂O₂ [symbol] H⁺+HO₂⁻ [Decomposition step]
b) Si+2HO₂⁻ [symbol] 2OH⁻+SiO₂ [Oxidation step]
c) SiO₂+2OH⁻ [symbol] H₂O+SiO₃²⁻ [Etching step]
d) Si+2HO₂⁻ [symbol] H₂O+SiO₃²⁻ [Etching]
e) Si+2OH⁻+H₂O [symbol] 2OH⁻+SiO₂ [Etching]
f) Si+2OH⁻+O₂ [symbol] H₂O+SiO₃²⁻ [Etching]
   Decomposition of H₂O₂ gives off O₂
      OH⁻+HO₂⁻O₂+H₂O2e⁻
   (a) Hydrogen peroxide, H₂O₂, at high pH is a powerful oxidant that decomposes to water and oxygen and at low pH, H₂O₂ is effective for desorbing metal contaminants, primarily, by complexing.
      H₂O₂z,1 H₂O+O₂
   (b) Ammonium hydroxide is a strong complexant for many metals.
      NH₄OH+H₂O [symbol] OH⁻[Dissolves SiO₂]
      SiO₂+OH⁻ [symbol] HSiO₃⁻[An overall reaction]

According to the present invention, an ultra-dilute RCA-1 which can be designated as _{ud}RCA1, and also referred to as ultra-dilute SC1 or _{ud}SC1, is used in treating/cleaning/preparing/conditioning quartz surfaces or other substrate surfaces, typically prior to metal film deposition. _{ud}SC1, like SC1 is a mixture of ammonium hydroxide, hydrogen peroxide and Deionized Water (DIW) at a lower dilution ratio of NH₄OH:H₂O₂:H₂O of 1:2:200 to 1:1:1000, preferred at 1:2:100 to 1:1:500, and more preferred at 1:2:100 to 1:2:500. All ratios are measured by volume. The use of high concentration SC1 was initiated over 20 years ago for sulfate ion removal after sulfuric acid-hydrogen peroxide clean. Since hydrogen peroxide in SC1 mixture decomposes faster for dilution ratio of 1:1:5, frequent addition of hydrogen peroxide is needed in order to maintain the required pH for cleaning. Depletion of hydrogen peroxide in the SC1 mixture results in surface roughness and pitting since hydrogen peroxide acts as a buffer for slowing down the etching characteristics of Ammonium hydroxide. Lower SC1 concentration reduces the frequency of hydrogen peroxide addition. Hydrogen peroxide in _{ud}SC1 is slowly decomposed and surface pitting is minimized. The operating pH range of _{ud}SC1 is between 8 and 12, and preferred between about 10, e.g., 10.1 and, 12. Various pH values are tabulated on Table 3 and a preferred effective operating pH range. falls between about 10.8 and 11.2, preferably 10.8 and 11.1.

Preferred are pH values greater than 8. A solution mixture with pH less than 7 will be too acidic for preferred embodiments of the process clean. If the pH is 7, the cleaning effectiveness is reduced.

Accordingly, the conductivity at the point-of-use (POU) of _{ud}SC1 mixture is preferably between 400 to 1720 μS/cm, preferable between 1230 to 1500 μS/cm, and between 1550 to 1710 μS/cm. Extensive conductivity values for SC1 and non-ionic detergent at various dilution ratios are shown on Tables 3 and 4.

This present invention for substrate and mask cleaning uses _{ud}SC1 mixture to condition both the surface and backside of substrate followed by alkaline-based non-ionic detergent treatment of the edges of the substrate.

Subsequent to the nonionic treatment, an alkaline non-ionic detergent composition treatment of the substrate with brush is performed for the backside and surface of the substrate. The nonionic detergent composition contains a mixture of nonionic detergent and deionized water (DIW) in the dilution ratio of 1 part of nonionic detergent to 100 parts of DIW measured by volume with more preferred range set between 1 part of nonionic detergent to 20 parts of DIW. The pH of the alkaline non-ionic detergent is about 8 to 11, preferably about 8.5 to 9.6. Table 3 contains details experimental data of pHs and conductivities for various dilution ratios.

The conductivity of the Detergent-DIW mixture is preferably between 120 and 550 μS/cm, more preferably between 120 and 230, and between 230 and 480 μS/cm.

Nonionic detergents that can be used in the invention are not limited generally. In general a detergent should be compatible with the product to be cleaned, e.g., non-reactive with the surface of the product to be cleaned. Mild cleaning solutions are preferred so that the surfactant solution would not be harsh on the product to be cleaned and damage the same in the cleaning process. Some amine and NO group containing detergents and cleaning solutions may be too reactive with certain products to be optimal choices as detergent. Nonionic surfactants/detergents useful in the present invention include, for example, polyethylene glycol-type nonionic surfactants such as an ethylene oxide adduct of higher alcohol, ethylene oxide adduct of alkyl phenol, ethylene oxide adduct of fatty acid, ethylene oxide adduct of polyhydric alcohol-fatty acid ester, ethylene oxide adduct of higher alkylamine, ethylene oxide adduct of fatty acid amide, ethylene oxide adduct of oil, ethylene oxide adduct of propylene glycol; polyhydric alcohol-type nonionic surfactant exemplified with fatty acid ester of glycerol, fatty acid ester of pentaerythritol, fatty acid ester of sorbitol or sorbitan, fatty acid ester of sucrose, polyhydric alcohol alkylether, fatty acid alkanol amide and alkylamine oxide.

Other examples of nonionic surfactants include alcohols or phenols having an alkyl group or an alkylphenyl group with carbon numbers of 8 to 22 to which 5 to 20 mol of ethylene oxide or propylene oxide is added. Amine oxides are also included. An N-alkyl-N,N-dimethylamine oxide of which alkyl group has carbon number of 8 to 20 can also be used, for example, N-lauryl-N,N-dimethylamine oxide. Cyclic amine oxides such as N-methylmorpholino amine oxide or N-methylpiperidinoamine oxide can also be used. Nonionic surfactants disclosed in U.S. Pat. No. 5,869,440 can also be used in this invention. Certain detergent containing cleaning products, e.g., the CLEANTHROUGH® series products of KAO Corporation of Japan are also useful.

Without being bound to theory, it has now been surprisingly found that a significant factor in the cleaning of quartz and other substrate surfaces involve the pH change from the _{ud}SC1 to the alkaline non-ionic detergent composition. That is, the pH variation from a higher pH value of the _{ud}SC1 composition to a lower pH value in the alkaline non-ionic detergent composition improves surface cleanliness results including maintaining surface integrity after cleaning. Both the cleaning efficiency as well as the consistency of results are optimized if the pH of the _{ud}SC1 composition is higher than the pH of the alkaline non-ionic detergent composition. The same results were not achieved when the pH values of the two compositions were reversed, i.e., the _{ud}SC1 composition having lower pH than the alkaline non-ionic detergent composition.

Preferably, the process of the present invention is performed with alkaline compositions only, meaning no acid solution mixtures/composition coming into contact with the substrate surface to be cleaned/treated.

Cleaning efficiency is further optimized if the conductivity value of the _{ud}SC1 composition is higher than the conductivity value of the alkaline non-ionic detergent. Preferably, the conductivity value of the _{ud}SC1 composition is higher by about 35-50%, preferably by 35-48%, by 40-45%, and by 45-50%, than the conductivity value of the alkaline non-ionic detergent.

Following the alkaline non-ionic detergent composition treatment, the substrate is typically subjected to spin rinse drying, followed by dehydration heat and then cooling.

The invention in one aspect includes spinning samples of quartz with particles and defects at defined rpm and discharging _{ud}SC1 composition onto the substrate surface. The substrate preferably is immediately quenched using CO₂-DIW mixture at a temperature ranging from ambient to about 85 degrees Centigrade to eliminate or at least reduce any possible micro-roughness and surface pitting.

Overall, the present invention provides an improved cleaning procedure over prior art methods and provides consistent high cleaning efficiency for substrates prior to metal film deposition. It is noteworthy that in all experiments conducted there was a variation of not greater than 0.05% in the results.

The cleaning invention involves 6-process steps as shown in FIG. 1 and this include (a) A high pH treatment step (SC1) for front and backside of sample, (b) A four-edge scrub for reducing particle recontamination, (c) backside proximity scrub with mechanical agitation with specific megasonic power for removing killer defects, e.g., larger particles, (d) frontside proximity scrub, mechanical agitation and spin rinse dry, (e) dehydration bake station for removing additional layer of moisture, and (f) dehydration cool station for bringing the sample surface temperature to ambient.

In the following preferred embodiment details of a process according to the invention are provided:
1. treating both surface and backside of substrate with _{ud}SC1 at a temperature of ambient through 80 degrees Centigrade, preferably 30 to 80, and more preferably 35 to 50 degrees Centigrade,
2. rinsing of surface and backside of substrate with CO₂-DIW after SC1 treatment on each of the surfaces. Both surface and backside of the substrate will experience constant CO₂-DIW rinse after SC1 treatment and during idle time,
3. subsequently treating the four edges of the substrate with the non-ionic detergent composition at a temperature of ambient through 80 degrees Centigrade, preferably 30 to 80, and 25 to 50 degrees Centigrade. Both surface and backside of substrate constantly experience CO₂-DIW rinse during chemical-inject of detergent on the edge brushes,
4. providing a scrubbing effect and/or mechanical agitation on the backside of the substrate, wherein the scrubbing is limited to proximity-type scrubbing and mechanical agitation is through, for example, megasonic nozzle.
5. the brushes for proximity (brushes do not touch the surface) scrubbing are compatible with nonionic detergent and the entire process step is hydro-dynamically controlled. The distance between the surface and the brushes for cleaning, are, for example, preferred from about 10 to 26 mm, preferably 12 to 20 mm, more preferably 13 to 18 mm.
6. frontside (surface) of the substrate will be rinsed with CO₂-DIW rinse during the nonionic detergent treatment,
7. providing a scrubbing effect and/or mechanical agitation on the surface of the substrate, wherein the scrubbing is limited to proximity-type scrubbing and mechanical agitation is through, for example, megasonic nozzle.
8. the brushes for proximity scrubbing are compatible with nonionic detergent and the entire process step is hydro-dynamically controlled. The distance between the surface and the brushes are for cleaning, are, for example, preferred from about 10 to 26 mm, preferably 12 to 20 mm, more preferably 13 to 18 mm.
9. backside of the substrate will be rinsed with CO₂-DIW rinse during the nonionic detergent treatment,
10. drying the substrate, preferably by spin rinse dry (SRD) and without any solvent such as IPA at high revolution per minute, e.g., 300 to 1400 rpm is initiated, preferable spin revolution is between 800 and 1400, and more preferred between 1100 and 1200 rpm, and
11. providing additional drying through dehydration heat with a temperature of 90 to 150 degrees Centigrade, preferably 100 to 140, and more preferred between 110 to 140 degrees Centigrade depending on the metal film surface (in this embodiment, the surface cleaned already had a metal layer deposited thereon),
12. substrate is cooled to ambient, preferably to 25±5 degrees Centigrade.

### BRIEF DESCRIPTION OF DRAWINGS

FIG. 1 illustrates a system suitable for performing a process according to the invention.

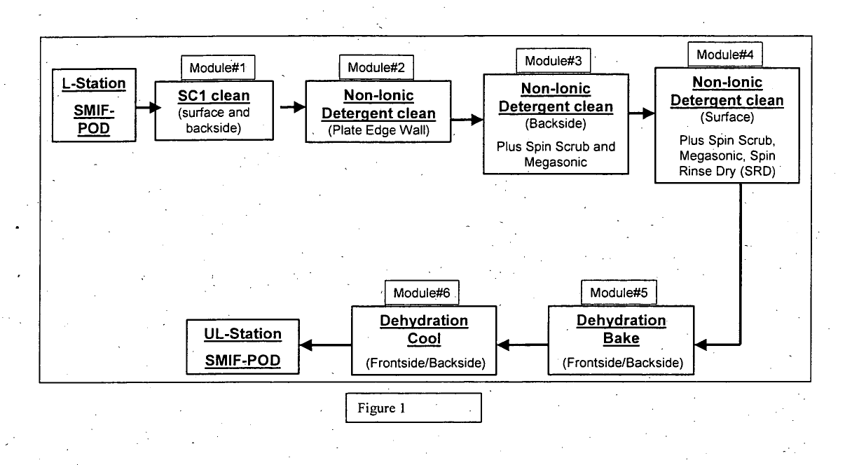

The following material describes the 6 main process steps, i.e., steps “a” through “f” or “i” through “vi” of the invention, each step being performed at a different module in the apparatus illustrated in FIG. 1.

Module #1 [symbol] SC1 clean module where point-of-use (POU) mixture of ammonium hydroxide, hydrogen peroxide and DIW is used for removing light to heavy organics as well as surface particles for both frontside and backside of plate. Module #1 also has the capability of continuous rinse of one surface while the other surface is undergoing SC1 clean.

Module #2 [symbol] Plate Edge Wall clean. In this module the edges and bevels are cleaned with PVA (polyvinyl acetate) brushes. The chemistry for this module is the non-ionic surfactant and DIW rinse follows the chemistry.

Module #3 [symbol] Backside Scrub clean. In this module, the backside of the plate is scrubbed with PVA brushes at a predetermined distance from the surface of the plate. The chemistry for this module is the non-ionic surfactant. Mechanical agitation is also applied with the use of the ultrasonic nozzle at a predetermined megasonic power. The frontside is simultaneously rinsed when the backside is being treated with the non-ionic surfactant.

Module #4 [symbol] Frontside Scrub clean and SRD (Spin Rinse Dry). In this module, the frontside of the plate is scrubbed with PVA brushes at a predetermined distance from the surface of the plate. The chemistry for this module is the non-ionic surfactant. Mechanical agitation is also applied with the use of the ultrasonic nozzle head at a predetermined megasonic power. The backside is simultaneously rinsed when the frontside is being treated with the non-ionic surfactant. Final step in this module is the spin and rinse dry step at 1200 RPM.

Module #5 [symbol] This is the Dehydration Bake module used for driving off multi-layer surface moisture on process plates after the SRD process step. Bake temperature is set at 120° C. and process time is optimized.

Module #6 [symbol] This is the Dehydration Cool module used for cooling down the plates prior to metal film deposition. Cool temperature is set to ambient.

In preferred embodiments, the invention is directed to:

### EXAMPLES/DATA

At the dilution ratio of 1:4:100 for temperature range of 25 to 50 degree Centigrade, SC1 chemistry:
Has no effects on the chrome film and does not micro-etch and/or causes any micro-roughness within the active and non-active areas
It does not change the optical properties and has little or effects on the reflectivity
It promotes rapid removal of light organics and particles

Table 1 provides data for 9 sample plates cleaned in accord with the invention under the same conditions, e.g., same process steps and with the same cleaning solutions.

TABLE 1

| | | Before Process clean | | | | After Process clean | | | |
|---|---|---|---|---|---|---|---|---|---|
| | | Particle sizes | | | | Particle sizes | | | |
| Plate # | Description | <0.6 μm | >0.6-1.6 μm | >1.6-3 μm | >3 μm | <0.6 mm | >0.6-1.6 μm | >1.6-3 μm | >3 μm |
| 1 | Surface | 5 | 0 | 0 | 0 | 3 | 0 | 0 | 0 |
| | Backside | 3 | 1 | 0 | 0 | 1 | 0 | 0 | 0 |
| 2 | Surface | 4 | 1 | 0 | 0 | 2 | 0 | 0 | 0 |
| | Backside | 3 | 0 | 0 | 0 | 0 | 0 | 0 | 0 |
| 3 | Surface | 15 | 0 | 1 | 5 | 5 | 0 | 0 | 0 |
| | Backside | 0 | 0 | 0 | 0 | 0 | 0 | 1 | 0 |
| 4 | Surface | 15 | 1 | 0 | 1 | 2 | 0 | 0 | 0 |
| | Backside | 4 | 0 | 0 | 1 | 1 | 0 | 0 | 0 |
| 5 | Surface | 30 | 0 | 0 | 4 | 6 | 0 | 0 | 0 |
| | Backside | 14 | 3 | 1 | 3 | 1 | 0 | 0 | 0 |
| 6 | Surface | 18 | 0 | 0 | 1 | 7 | 0 | 0 | 0 |
| | Backside | 9 | 1 | 1 | 0 | 1 | 0 | 0 | 0 |
| 7 | Surface | 23 | 2 | 0 | 1 | 9 | 1 | 0 | 0 |
| | Backside | 14 | 0 | 0 | 0 | 4 | 1 | 0 | 0 |
| 8 | Surface | 12 | 1 | 2 | 0 | 6 | 0 | 0 | 0 |
| | Backside | 4 | 0 | 0 | 0 | 3 | 0 | 0 | 0 |
| 9 | Surface | 9 | 0 | 0 | 0 | 2 | 0 | 0 | 0 |
| | Backside | 1 | 0 | 0 | 1 | 0 | 0 | 0 | 0 |

Table 2 provides results of AFM (atomic force microscope) for 2 μm images of a surface before and after SC1 cleaning.

TABLE 2

| | Pre-SC1 Clean | | Post-SC1 Clean | |
|---|---|---|---|---|
| Description | Ra (nm) | RMS(Rq) (nm) | Ra (nm) | RMS, Rq (nm) |
| Noise Level | 0.024 | 0.031 | 0.024 | 0.031 |
| Roughness | 0.11 | | 0.10 | |
| Mean Roughness | 0.168 | | 0.11 | |

Table 3 provides optical properties for the Binary Chrome Surface before and after SC1 cleaning.

TABLE 3

| Description | Pre-SC1 Clean | Post-SC1 Clean |
|---|---|---|
| OD, 436 nm | 3.05 | 3.04 |
| Reflectivity, | 11.189 | 10.94 |
| 464 nm | | |
| Reflectivity, | 15.01 | 14.97 |
| 488 nm | | |

In table 3, OD refers to omnidirectional reflectivity.

Centigrade

Table 4 characterizes SC1 solutions at various dilution ratios and temperatures and provides pH and conductivity information.

TABLE 4
SC1 Characterization

| | | | Conductivity |
|---|---|---|---|
| Dilution Ratio | Temperature C. | pH | μS/cm |
| 1:1:100 | 20 | 10.59 | 950 |
| | 22 | 10.45 | 240 |
| | 26 | 10.37 | 50 |
| 1:1:200 | 20 | 10.62 | 800 |
| | 22 | 10.53 | 870 |
| | 23 | 10.63 | 840 |
| 1:1:500 | 20 | 10.35 | 370 |
| | 22 | 9.93 | 370 |
| 1:2:100 | 20 | 11.11 | 1550 |
| | 22 | 10.87 | 1710 |
| 1:2:200 | 20 | 10.43 | 1040 |
| | 21 | 10.26 | 1070 |
| | 23 | 10.21 | 1060 |
| | 25 | 10.15 | 20 |
| 1:2:500 | 20 | 10.4 | 690 |
| | 22 | 10.13 | 600 |

Table 5 characterizes a detergent solution at various dilution ratios and temperatures and provides pH and conductivity information.

TABLE 5

| | | | Conductivity |
|---|---|---|---|
| Dilution Ratio | Temperature C. | PH | μS/cm |
| 1:1 | 20 | 9.59 | 3290 |
| | 21 | 9.61 | 3280 |
| | 22 | 9.62 | 3320 |
| | 23 | 9.56 | 3340 |
| | 26 | 9.57 | 3270 |
| 1:2 | 20 | 9.51 | 2440 |
| | 23 | 9.31 | 2440 |
| | 25 | 9.51 | 2350 |
| | 26 | 9.46 | 2460 |
| 1:3 | 20 | 9.47 | 1960 |
| | 24 | 9.44 | 1950 |
| | 26 | 9.43 | 1930 |
| 1:5 | 20 | 9.41 | 1230 |
| | 22 | 9.18 | 1200 |
| | 26 | 9.39 | 1250 |

Modification and variations of the present invention are possible in light of the above statements. It is, therefore, to be understood that changes may be made in the particular embodiments of the invention described which are within the fully intended scope of the invention.

1. A method for cleaning a substrate surface comprising
treating the substrate surface with a _{ud}SC1 composition having a pH of 8 to 12, which contains ammonium hydroxide, hydrogen peroxide and deionized water at a dilution ratio of NH₄OH:H₂O₂:H₂O of 1:2:200 to 1:1:1000 parts by volume, and subsequently treating the substrate surface with a non-ionic detergent composition having a pH of 8 to 11, which contains a non-ionic detergent and deionized water at a dilution ratio of 1 to 100 parts by volume,
wherein the pH of _{ud}SC1 is higher than that of the non-ionic detergent composition.

2. A method according to claim 1, wherein the cleaning achieves conditioning and/or controlling particles, defects, metals, organic or inorganic contaminants on substrate surfaces.

3. A method according to claim 1, wherein the substrate surface is a metal coated surface.

4. A method according to claim 1, wherein the substrate surface is quartz.

5. A method according to claim 1, wherein the conductivity value of _{ud}SC1 is higher than that of the non-ionic detergent composition.

6. A method according to claim 1, wherein the conductivity value of _{ud}SC1 is 400 to 1000 μ/cm.

7. A method according to claim 1, wherein the conductivity value of the non-ionic detergent composition is 120 to 550 μS/cm

8. A method according to claim 1, wherein essentially no acidic solution mixture contacts the substrate surface during or before cleaning.

9. A method according to claim 4, further comprising providing a proximity scrubbing effect plus mechanical agitation in the form of ultrasonic power on the surface of the substrate.

10. A method according to claim 1, further comprising rinsing off the substrate with a carbonated-DIW mixture.

11. A method according to claim 1 further comprising drying the substrate by spin rinse dry at 300to 1400 rpm

12. A method according to claim 1, further comprising drying the substrate through dehydration heat with temperature of 90 to 200 degrees Centigrade.

13. A method according to claim 1, further comprising drying the substrate through dehydration heat with temperature of about 120° C.

14. A method according to claim 1, further comprising mechanically agitating by the application of ultrasonic power and proximity-type scrubbing the substrate surface.

15. A method according to claim 1, further comprising depositing a film of metal onto the substrate surface after cleaning.

16. A kit for cleaning a substrate surface comprising
a _{ud}SC1 composition having a pH of 8 to 12, which contains ammonium hydroxide, hydrogen peroxide and deionized water at a dilution ratio of NH₄OH:H₂O₂:H₂O of 12:200 to 1:1:1000 parts by volume, and
a non-ionic detergent composition having a pH of 8 to 11, which contains a non-ionic detergent and deionized water at a dilution ratio of 1 to 100 parts by volume,
wherein the pH of the _{ud}SC1 composition is higher than of the non-ionic detergent composition.

17. A kit according to claim 15, wherein the conductivity value of the _{ud}SC1 composition is higher than of the non-ionic detergent composition.

18. A kit according to claim 15, further comprising instructions on using the kit for cleaning, conditioning and/or controlling particles, defects, metals, organic or inorganic contaminants on a substrate surface by treating the substrate surface with _{ud}SC1 followed by treating the substrate surface with the non-ionic detergent composition.
